(19) United States
(12) Patent Application Publication
(10) Pub. No.: US 2008/0113325 A1
(43) Pub. Date: May 15, 2008

(54) TV OUT ENHANCEMENTS TO MUSIC LISTENING

(75) Inventors: Anders Mellqvist, Malmo (SE); Christian Ewertz, Bunkeflostrand (SE)

Correspondence Address: HARRITY SNYDER, L.L.P., 11350 RANDOM HILLS ROAD, SUITE 600, FAIRFAX, VA, 22030, US

(73) Assignee: Sony Ericsson Mobile Communications AB, Lund (SE)

(21) Appl. No.: 11/558,224

(22) Filed: Nov. 9, 2006

(51) Int. Cl. G06F 17/30; G09B 5/00; G06Q 30/00

(52) U.S. Cl. 434/307 A; 707/10; 705/27; 707/E17.008

(57) ABSTRACT

A method performed by a mobile terminal may include selecting a song, receiving information associated with the selected song and simultaneously outputting the selected song with received music information to a plurality of output devices. The method may also include displaying lyrics of the song while simultaneously playing the song.

### TECHNICAL FIELD OF THE INVENTION

Systems and methods described herein generally relate to communications devices and, more particularly, to displaying information related to music applications for communications devices.

### DESCRIPTION OF RELATED ART

Communication devices, such as cellular telephones, have become increasingly versatile. For example, cellular telephones often include music features that enable users to obtain and play songs. At the present time, the display features employed on cellular telephones and portable communications devices have limited capabilities and functionalities related to the music features on the devices.

### SUMMARY

According to one aspect, a method performed by a mobile terminal comprises selecting a song; transmitting information identifying the selected song to a server; receiving music information associated with the selected song from the server; and simultaneously outputting the selected song and the received information to a plurality of output devices.

Additionally, the simultaneously outputting the selected song and the received information to a plurality of output devices may further comprise: outputting the selected song for playing on a stereo system and outputting the received information for display on a television or monitor.

Additionally the music information may comprise a video pre-programmed to display images synchronized with the selected song.

Additionally, the received information may comprise text information associated with the selected song.

Additionally, the received information may be information relating to an artist of the selected song.

According to another aspect, a mobile terminal is provided. The mobile terminal comprises a memory for storing audio files corresponding to a plurality of songs; and logic configured to: connect to a network; select one of the plurality of songs; receive information associated with the selected song via the network; and simultaneously output the selected song and the received information associated with the selected song.

Additionally, the logic may be configured to synchronize the received information with the selected song.

Additionally, the received information may comprise a video pre-programmed to display images synchronized with the selected song.

Additionally, the logic may be further configured to store the received information.

Additionally, when simultaneously outputting the selected song and the received information the logic may be further configured to simultaneously output the selected song and the received information to a stereo system and a television.

According to another aspect, a method is provided. The method comprises selecting a song; receiving song lyrics associated with the selected song via a network; receiving input from a microphone; combining at least a portion of the selected song and the received input from the microphone to form a combined music signal; and simultaneously outputting the combined music signal to a first output device and outputting the song lyrics to a second output device.

Additionally, the method may further comprise suppressing vocal information in the selected song.

Additionally, the first output device may comprise a stereo system and the second output device may comprise a monitor.

Additionally, the method may further comprise transmitting information to identify the selected song to a server, wherein the server identifies the selected song and obtains song lyrics associated with the selected song.

Additionally, the method may further comprise synchronizing the received song lyrics with the selected song.

According to another aspect, a mobile terminal is provided. The mobile terminal comprises a memory for storing a plurality of songs; a microphone for receiving input; and logic configured to: select one of the plurality of songs stored in the memory; receive song lyrics associated with the selected song; combine the received input from the microphone with at least a portion of the selected song to form a combined music signal; and simultaneously outputting the combined music signal to a first output device and outputting the received song lyrics to a second output device.

Additionally, the logic is further configured to: suppress vocals in the selected song.

Additionally, the logic may be further configured to: synchronize the combined music signal with the received song lyrics associated with the selected song.

Additionally, wherein the logic may be further configured to: transmit information identifying the selected song to a server, wherein the server identifies the selected song and obtains the song lyrics associated with the selected song.

Additionally, the first output device may comprise a stereo and the second output device may comprise a television.

According to another aspect, a mobile terminal is provided. The mobile terminal comprises means for selecting a song; means for transmitting information identifying the selected song to a server; means for receiving information associated with the selected song from the server; and means for simultaneously outputting the selected song and the received information.

Additionally, the received information may comprise at least one of concert related information or information associated with purchasing a song.

Additionally, the received information may comprise at least a portion of a song by a same artist or group associated with the selected song.

Additionally, the means for simultaneously outputting the selected song and the received information may further comprise: means for outputting the selected song via a speaker on the mobile terminal and means for outputting the received information via a display on the mobile terminal.

Other features and advantages of the systems and methods described herein will become readily apparent to those skilled in this art from the following detailed description. The implementations shown and described provide illustration of the best mode contemplated for carrying out the embodiments. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 is a diagram of an exemplary server shown in FIG. 1;

FIG. 3 is a diagram of an exemplary mobile terminal as shown in FIG. 1;

FIG. 4 shows an exemplary mobile terminal;

FIG. 5 shows an exemplary system including a mobile terminal;

FIG. 6 is a flow diagram illustrating exemplary processing by a mobile terminal; and

FIG. 7 is a flow diagram illustrating exemplary processing by a mobile terminal.

### DETAILED DESCRIPTION

The following detailed description refers to the accompanying drawings. The same reference numbers in different drawings identify the same or similar elements. Also, the following detailed description does not limit the systems and methods described herein. Instead, the scope of the systems and methods are defined by the appended claims and equivalents.

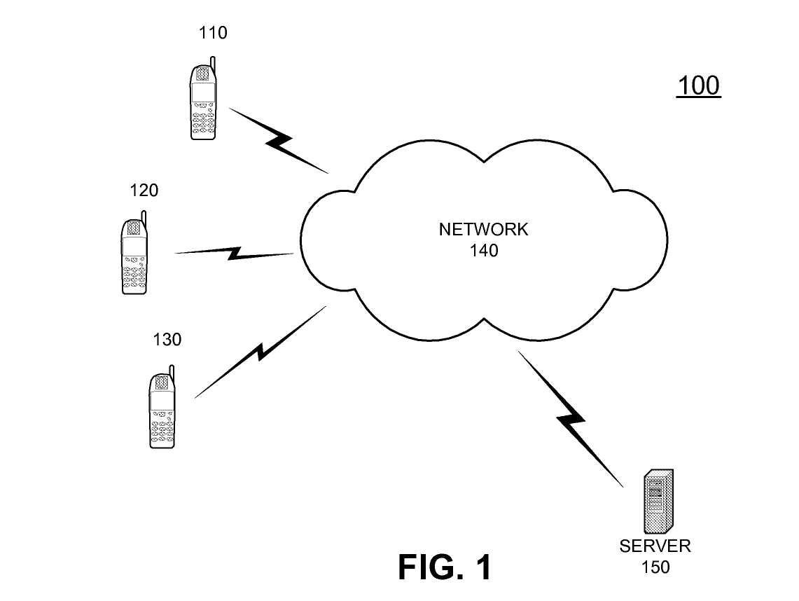

FIG. 1 is a diagram of an exemplary system 100 in which methods and systems described herein may be implemented. System 100 may include mobile terminals 110, 120 and 130, and server 150, connected via network 140. It should be understood that system 100 may include other numbers of mobile terminals, networks and servers.

Methods and systems described herein may be implemented in the context of a mobile terminal, such as one of mobile terminals 110-130. As used herein, the term “mobile terminal” may include a cellular radiotelephone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver, a radio (AM/FM) receiver; and a laptop and/or palmtop receiver or other appliance that includes a radiotelephone transceiver. Mobile terminals may also be referred to as “pervasive computing” devices that are capable of communicating with other devices via protocols that allow for simultaneous communications of voice, data, music and video information, for example.

Network 140 may include one or more networks, such as a cellular network, a satellite network, the Internet, a telephone network, such as the Public Switched Telephone Network (PSTN), a metropolitan area network (MAN), a wide area network (WAN), a local area network (LAN), or a combination of networks. Mobile terminals 110, 120 and 130 may communicate with each other over network 140 via wired, wireless or optical connections.

In an exemplary implementation, network 140 includes a cellular network used for transmitting data between mobile terminals 110-130 and server 150. For example, components of a cellular network may include base station antennas (not shown) that transmit and receive data from mobile terminals within their vicinity. Other components of a cellular network, for example, may include base stations (not shown) that connect to the base station antennas and communicate with other devices, such as switches and routers (not shown) in accordance with known techniques.

Server 150 may include one or more processors or microprocessors enabled by software programs to perform functions, such as data storage and transmission, and interfacing with other servers (not shown) and mobile terminals 110-130, for example. Server 150 may also include a data storage memory such as a random access memory (RAM) or another dynamic storage device that stores information, such as music information, as described in detail below.

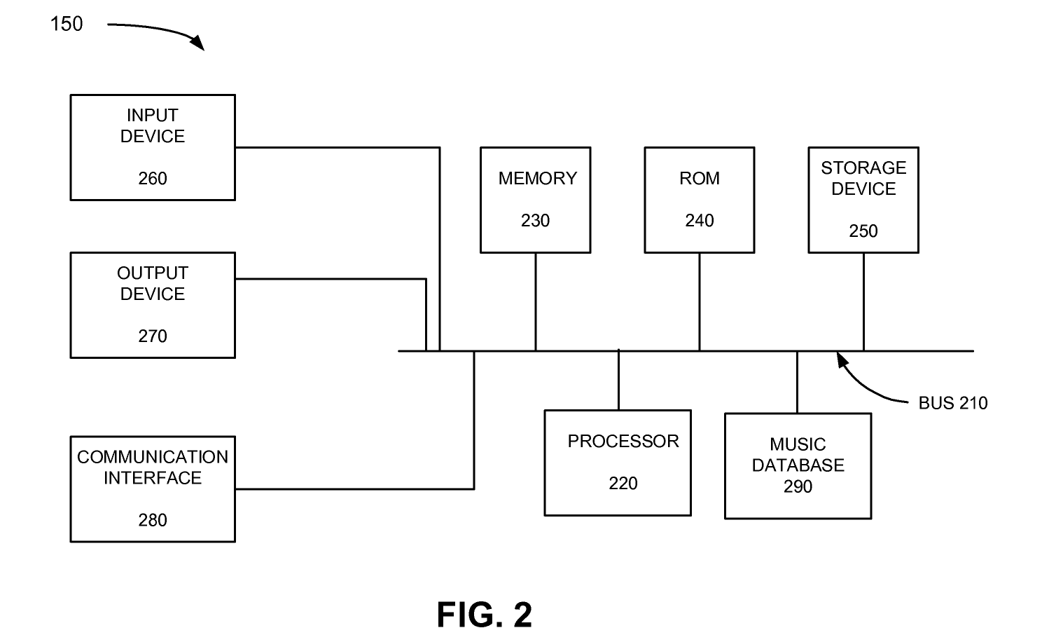

FIG. 2 is a diagram of an exemplary configuration of server 150. Server 150 may include bus 210, processor 220, a memory 230, a read only memory (ROM) 240, a storage device 250, an input device 260, an output device 270, a communication interface 280, and a music database 290. Server 150 may also include one or more power supplies (not shown). One skilled in the art would recognize that server 150 may be configured in a number of other ways and may include other or different elements.

Bus 210 permits communication among the components of server 150. Processor 220 may include any type of processor, microprocessor, or processing logic that may interpret and execute instructions. Processor 220 may also include logic that is able to decode media files, such as audio files, video files, etc., and generate output to, for example, a speaker, a display, etc. Memory 230 may include a random access memory (RAM) or another dynamic storage device that stores information and instructions for execution by processor 220. Memory 230 may also be used to store temporary variables or other intermediate information during execution of instructions by processor 220.

ROM 240 may include a ROM device and/or another static storage device that stores static information and instructions for processor 220. Storage device 250 may include a magnetic disk or optical disk and its corresponding drive and/or some other type of magnetic or optical recording medium and its corresponding drive for storing information and instructions. Storage device 250 may also include a flash memory (e.g., an electrically erasable programmable read only memory (EEPROM)) device for storing information and instructions.

Input device 260 may include one or more mechanisms that permit a user to input information to server 150, such as a keyboard, a mouse, a microphone, a pen, voice recognition and/or biometric mechanisms, etc. Output device 270 may include one or more mechanisms that output information to the user, including a display, a printer, etc.

Communication interface 280 may include any transceiver-like mechanism that enables server 150 to communicate with other devices and/or systems. For example, communication interface 280 may include a modem or an Ethernet interface to a LAN. In addition, communication interface 280 may include other mechanisms for communicating via a network, such as a wireless network. For example, communication interface 280 may include one or more radio frequency (RF) transmitters, and one or more RF receivers and antennas for transmitting and receiving RF signals. Communication interface 280 may also include transmitters/receivers for communicating with mobile terminals 110-130, that may include receiving songs or music information from mobile terminals 110-130 and transmitting music related information to mobile terminals 110-130, as described in detail below.

Music database 290 may contain, for example, audio files of songs and music information that may be associated with the songs or artists. For example, music related information stored in music database 290 may include song lyrics, text information about the song/artist, video data, picture data, and web-based information. For example, songs may be stored as audio files in MP3 format, for example. Video data and song lyrics may be stored in music database 290 in a timed format, for example, that may be synchronized with an associated song. Processor 220 and/or music database 290 may also perform processing for identifying a received song based on analyzing the received audio data of the song or other information associated with the song, and for obtaining associated stored music information with the identified song. For example, processor 220 and/or music database 290 may receive a title of a song transmitted from mobile terminal 110, identify the song, and then transmit music information associated with the identified song to mobile terminal 110. Music database 290 may also store web-based information relating to the identified song/artist, for example, websites or chatrooms associated with an artist.

According to an exemplary implementation, server 150 may perform various processes in response to processor 220 executing sequences of instructions contained in memory 230. Such instructions may be read into memory 230 from another computer-readable medium, such as storage device 250, or from a separate device via communication interface 280. It should be understood that a computer-readable medium may include one or more memory devices or carrier waves. Execution of the sequences of instructions contained in memory 230 causes processor 220 to perform the acts that will be described hereafter. In alternative embodiments, hardwired circuitry may be used in place of or in combination with software instructions to implement aspects of the embodiments. Thus, the systems and methods described herein are not limited to any specific combination of hardware circuitry and software.

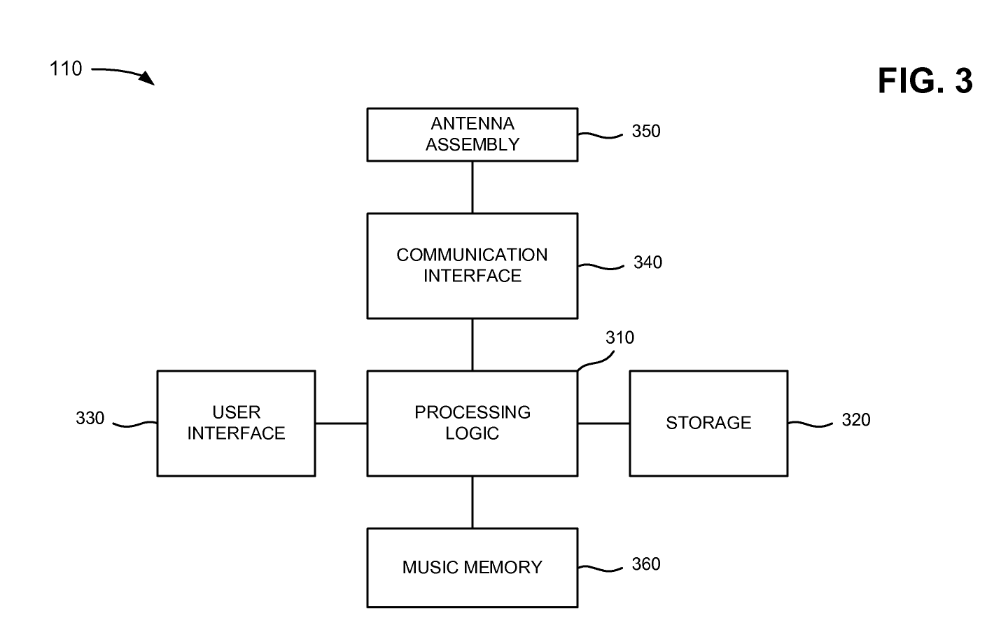

FIG. 3 is a diagram of exemplary components of mobile terminal 110. As shown in FIG. 3, mobile terminal 110 may include processing logic 310, storage 320, user interface 330, communication interface 340, antenna assembly 350, and music memory 360. Processing logic 310 may include a processor, a microprocessor, an application specific integrated circuit (ASIC), a field programmable gate array (FPGA), or the like. Processing logic 310 may include data structures or software programs to control the operation of mobile terminal 110 and its components. Storage 320 may include a random access memory (RAM), a read only memory (ROM), and/or another type of memory to store data and instructions that may be used by processing logic 310.

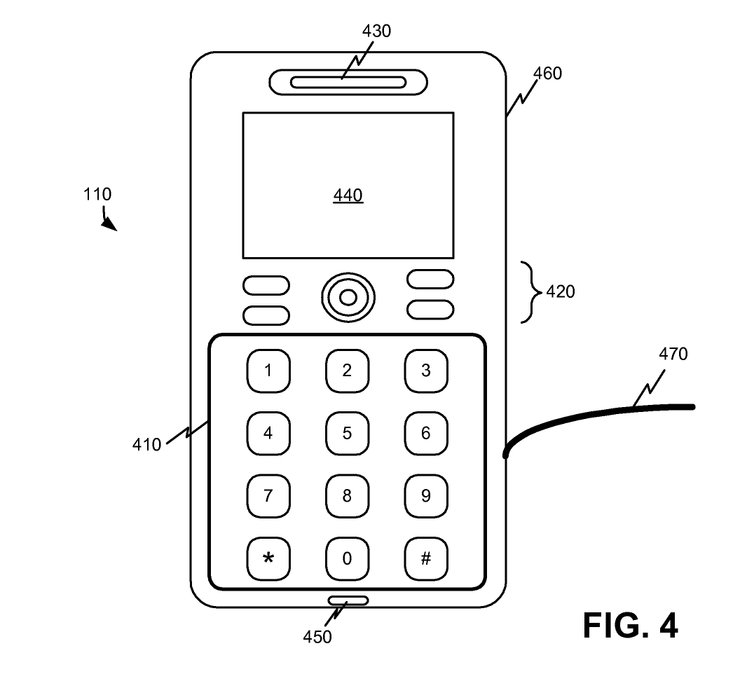

User interface 330 may include mechanisms for inputting information to mobile terminal 110 and/or for outputting information from mobile terminal 110. Examples of input and output mechanisms may include a speaker to receive electrical signals and output audio signals, a microphone to receive audio signals and output electrical signals, control buttons and/or keys on a keypad to permit data and control commands to be input into mobile terminal 110, and a display to output visual information. These exemplary types of input and output mechanisms contained in user interface 330 are shown and described in greater detail in FIG. 4.

Communication interface 340 may include, for example, a transmitter that may convert baseband signals from processing logic 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and reception of the RF signals. Antenna assembly 350 may include one or more antennas to transmit and receive RF signals over the air. Antenna assembly 350 may receive RF signals from communication interface 340 and transmit them over the air and receive RF signals over the air and provide them to communication interface 340.

Music memory 360 may contain a plurality of audio music files stored as songs for example. For example, music memory 360 may contain audio music files stored in an MP3 format, an MPEG4/3GPP format, or some other format. Music memory 360 also may perform certain operations relating to receiving downloaded or streamed music information and synchronizing received music information with a selected song. For example, music memory 360 may receive lyrics in a timed format from server 150, and then synchronize and output the downloaded lyrics with the song. Memory 360 may further perform processing on audio files in order to suppress vocal information of stored songs to allow for a Karaoke feature, for example. In different implementations, received music information from server 150 may be stored in music memory 360 for later retrieval. For example, music memory 360 may store a downloaded audio file of a song from server 150.

As will be described in detail below, mobile terminal 110 may perform these operations in response to processing logic 310 executing software instructions contained in a computer-readable medium, such as storage 320.

The software instructions may be read into storage 320 from another computer-readable medium or from another device via communication interface 340. The software instructions contained in storage 320 may cause processing logic 310 to perform processes that will be described later. Alternatively, hardwired circuitry may be used in place of or in combination with software instructions to implement processes consistent with the embodiments described herein. Thus, implementations consistent with the principles of the embodiments described herein are not limited to any specific combination of hardware circuitry and software.

FIG. 4 shows an exemplary mobile terminal 110 that may include housing 460, keypad 410, control keys 420, speaker 430, display 440, microphone 450 and media cable 470. Housing 460 may include a structure configured to hold components used in mobile terminal 110. Housing 460 may be formed from plastic, metal, or composite and may be configured to support keypad 410, control keys 420, speaker 430, display 440, microphone 450, and receive media cable 470.

Keypad 410 may include keys that can be used to operate mobile terminal 110. Keypad 410 may further be adapted to receive user inputs, directly or via other devices, such as a stylus for entering information into mobile terminal 110. In one implementation, communication functions of mobile terminal 110 may be controlled by activating keys in keypad 410. Implementations of keys may have key information associated therewith, such as numbers, letters, symbols, etc. The user may operate keys in keypad 410 to place calls, enter digits, commands, and text messages, into mobile terminal 110. Designated functions associated with keys may form and/or manipulate images that may be displayed on display 440.

Control keys 420 may include buttons that permit a user to interact with mobile terminal 110 to perform specified actions, such as to interact with display 440, etc. For example, a user may use control keys 420 to access and scroll through a list of stored songs and select a song.

Speaker 430 may include a device that provides audible information to a user of mobile terminal 110. Speaker 430 may be located anywhere on mobile terminal 110 and may function, for example, as an earpiece when a user communicates using mobile terminal 110. Speaker 430 may also function as an output device for playing music.

Display 440 may include a device that provides visual images to a user. For example, display 440 may present a list of songs to a user. Display 440 may also display graphic information regarding incoming/outgoing calls, text messages, games, phonebooks, the current date/time, volume settings, etc., to a user of mobile terminal 110. Display 440 may be implemented as a black and white or a color display or some other type of display.

Microphone 450 may include a device that converts speech or other acoustic signals into electrical signals for use by mobile terminal 110. Microphone 450 may be located anywhere on mobile terminal 110 and may be configured, for example, to convert spoken words or singing into electrical signals for use by mobile terminal 110.

Media cable 470 may include a cable capable of connecting to mobile terminal 110 and simultaneously transmitting both audio and video signals from mobile terminal 110 to a plurality of remote devices. For example, mobile terminal 110 may be configured to support a “TV Out” functionality, wherein video data may be transmitted from mobile terminal 110 via media cable 470 to a television for display, while audio data may be transmitted through media cable 470 to an audio device, such as a stereo system for example or to a speaker associated with a television.

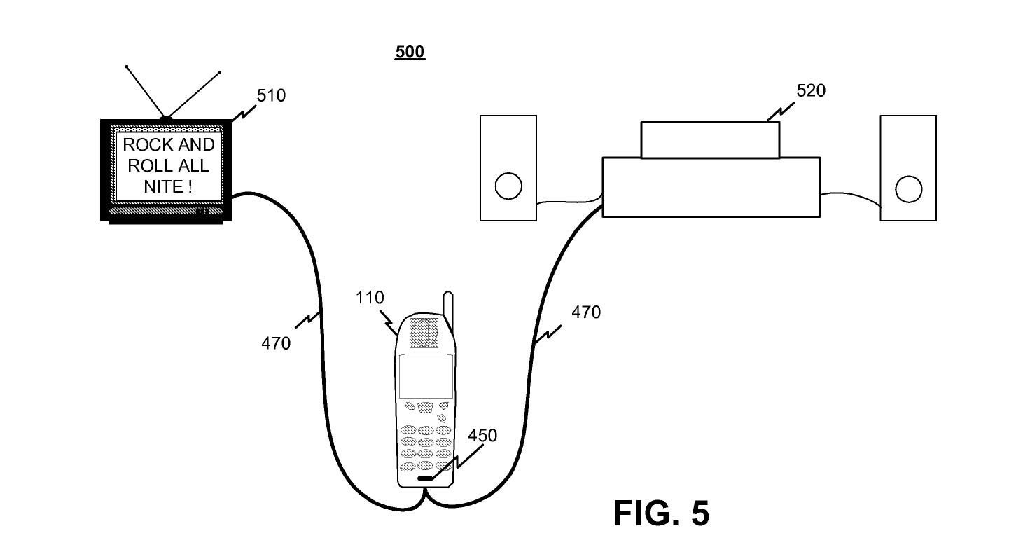

FIG. 5 illustrates an exemplary system 500. System 500 may contain mobile terminal 110 that includes microphone 450 and media cable 470, television (TV) 510 and stereo system 520, for example. Television 510 may include a receiving, processing and displaying means for receiving and processing signals (analog or digital) and displaying the processed signals as pictures on the displaying means. For example, the displaying means of TV 510 may include a Cathode Ray Tube (CRT), Liquid Crystal Display (LCD), plasma type display, projection type display or any other type of screen capable of displaying information. Stereo system 520 may include means for receiving, amplifying and outputting music. For example, stereo system 520 may include receivers, tuners, amplifiers and speakers, for example. Media cable 470 may include a cable capable of transmitting electrical signals from mobile terminal 110 to TV 510 and stereo system 520, for example. In other implementations, mobile terminal 110 may transmit RF signals to TV 510 and stereo system 520 via, for example, a wireless LAN.

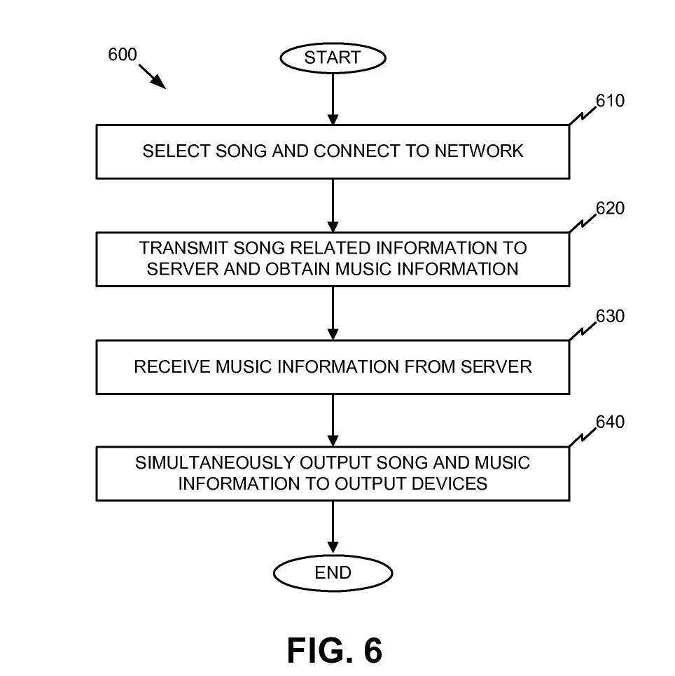

FIG. 6 illustrates an exemplary processing 600 performed by mobile terminal 110. Processing may begin when a user of mobile terminal 110 selects a song and connects to the network 140 (act 610). For example, using control keys 420, a user may select a song from a displayed list of songs on display 440. In response to selecting a song, mobile terminal 110 may automatically establish a connection to server 150 via network 140 (act 610). Once connected to server 150, mobile terminal 110 may transmit information identifying the selected song, such as the title of the song, to server 150, where server 150 identifies the song and obtains music-related information associated with the song (act 620). For example, music database 290 may include software that receives song related information, such as a song title and may identify the received song. As described above, music database 290 may also store a plurality of music information associated with songs and/or artists, for example. Stored music information may include song lyrics, music videos, video and/or picture information, text information, and information relating to the song/artists, such as facts about the artist, concert ticket information associated with the artist, song downloading and purchasing information, etc. The stored music information may also include other songs associated with an artist, such as sample tracks, etc. Once the received song related information is identified by server 150, the associated music information may be transmitted from server 150 and received by mobile terminal 110 (act 630).

For example, the associated music information may be a video associated with the identified song. In this example, mobile terminal 110 may then simultaneously output the song and the associated video to a plurality of output devices (act 640). The associated video (music information) may include flashing lights or graphical shapes that may change in a synchronized manner with the beat of the song, for example. The associated music information may also be any other form of video data (pictures, lyrics or text) that may be stored in a timed format in music database 290. The music information stored in music database 290 may include any type of information that may be preprogrammed to be synchronized with an associated song.

As there may be minor transmission delays and processing delays in both server 150 and mobile terminal 110, server 150 may be configured to transmit the music information to mobile terminal in a manner that may allow mobile terminal 110 to receive and synchronize the received music information (lyrics or video information) with the selected song. For example, server 150 may stream or transmit lyrics to mobile terminal 110 a few seconds before the lyrics may be heard in the selected song, so that mobile terminal 110 may receive, process and synchronize the received lyrics with the selected song. Mobile terminal 110 may then output lyrics that may be synchronized with the selected song to TV 510 and stereo system 520, for example. Alternatively, mobile terminal 110 may play the selected song on its speaker 430 and display lyrics via its display 440.

In further embodiments, music information received from server 150 (act 630) may be text information relating to an identified artist, for example. For example, news, concert information, ticket services, song release dates, may be provided by server 150 to mobile terminal 110 and displayed via TV 510, display 440 or some other display or monitor (act 640). In this example, a user may choose to buy concert tickets or purchase a song for example, based on the information displayed on TV 510 or display 440 (act 640), for example. If a user purchases a song for example, the song may be downloaded from server 150 and stored in music memory 360. Music information received in act 630 may also include websites and/or links related to the song/artist, such as an artists' homepage or a discussion board relating to the song/artist, for example.

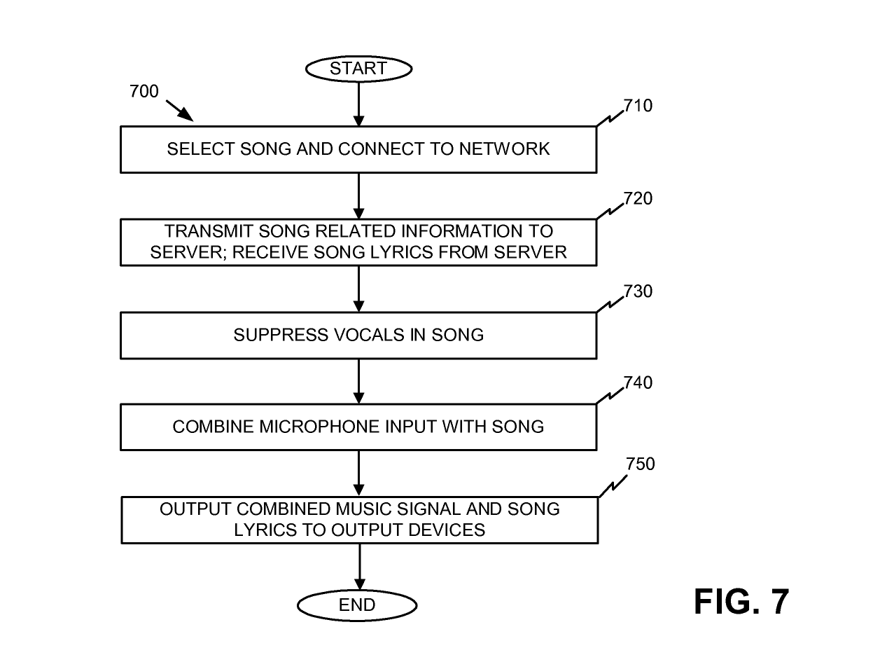

FIG. 7 illustrates exemplary processing 700 performed by mobile terminal 110 in another implementation that is associated with a Karaoke feature. Processing may begin when a user of mobile terminal 110 selects a song and connects to the network 140 (act 710). For example, using control keys 420, a user may select a song from a displayed list of songs on display 440. In response to selecting a song for example, mobile terminal 110 may automatically establish a connection to server 150 via network 140 (act 710). Once connected to server 150, mobile terminal 110 may transmit information identifying the selected song, such as the song title, to server 150, where server 150 identifies the song and transmits associated song lyrics to mobile terminal 110 (act 720).

In order to enhance a Karaoke feature, for example, mobile terminal 110 may suppress the vocal portion of the song (act 730). For example, music memory 360 may contain software that allows processing logic 310 to dynamically alter the audio file of a song for use in a Karaoke mode. In this mode, the resulting output of the song from mobile terminal 110 may contain only the music portion, for example. Simultaneously, while the vocals of the selected song may be suppressed, vocal input from a user may be received via microphone 450 and combined with the song (act 740). For example, a user of mobile terminal 110 may sing into microphone 450, where the vocal input received through microphone 450 may be combined with the selected song (with vocals suppressed) from music memory 360. The combined music signal that may contain the song with suppressed vocals and received vocal input from microphone 450 may be simultaneously output with song lyrics to the output devices (act 750). As shown in FIG. 5 for example, the combined music signal that may include a selected song with suppressed vocals, “Rock and Roll All Nite,” and user vocals received via microphone 450, may be transmitted via media cable 470 to stereo system 520, while the song lyrics may be simultaneously output and transmitted via media cable 470 to TV 510 for display (act 750). In this manner, mobile terminal 110 may provide Karaoke functionality with TV 510 and stereo system 520, for example. In alternative implementations, the combined music signal may be played via speaker 430 and the lyrics may be displayed via display 440.

### CONCLUSION

Implementations consistent with the systems and methods described herein may allow mobile terminals to automatically receive and output music-related information associated with a selected song. This greatly enhances the capabilities of mobile terminals. In addition, various embodiments also enable a mobile terminal to receive, synchronize and output lyrics in a manner that enables Karaoke functionality.

The foregoing description of the embodiments provides illustration and description, but is not intended to be exhaustive or to limit implementations to the precise form disclosed. Modifications and variations are possible in light of the above teachings or may be acquired from practice of the implementations.

For example, the embodiments have been described in the context of a mobile terminal receiving music-related information from a network. In addition, the embodiments have been described as being implemented by mobile terminals connected to a communications network. The embodiments may be implemented in other devices or systems and/or networks.

Further, while series of acts have been described with respect to FIGS. 6-7, the order of the acts may be varied in other implementations. Moreover, non-dependent acts may be performed in parallel.

It will also be apparent to one of ordinary skill in the art that aspects of the implementations, as described above, may be implemented in cellular communication devices/systems, methods, and/or computer program products. Accordingly, the implementations may be embodied in hardware and/or in software (including firmware, resident software, micro-code, etc.). Furthermore, the implementations may take the form of a computer program product on a computer-usable or computer-readable storage medium having computer-usable or computer-readable program code embodied in the medium for use by or in connection with an instruction execution system. The actual software code or specialized control hardware used to implement aspects of the embodiments is not limiting of the systems and methods described. Thus, the operation and behavior of the aspects were described without reference to the specific software code—it being understood that one of ordinary skill in the art would be able to design software and control hardware to implement the aspects based on the description herein.

Further, certain portions of the embodiments may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof

No element, act, or instruction used in the description of the present application should be construed as critical or essential to the systems and methods described unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the systems and methods described herein are defined by the claims and their equivalents.

What is claimed is:

1. A method performed by a mobile terminal comprising:
selecting a song;
transmitting information identifying the selected song to a server;
receiving information associated with the selected song from the server; and
simultaneously outputting the selected song and the received information to a plurality of output devices.

2. The method of claim 1, wherein the simultaneously outputting the selected song and the received information to a plurality of output devices further comprises:
outputting the selected song for playing on a stereo system and outputting the received information for display on a television or a monitor.

3. The method of claim 1, wherein the received information comprises a video pre-programmed to display images synchronized with the selected song.

4. The method of claim 1, wherein the received information comprises text information associated with the selected song.

5. The method of claim 1, wherein the received information comprises information relating to an artist of the selected song.

6. A mobile terminal, comprising:
a memory for storing audio files corresponding to a plurality of songs; and
logic configured to:
connect to a network;
select one of the plurality of songs;
receive information associated with the selected song via the network; and
simultaneously output the selected song and the received information associated with the selected song.

7. The mobile terminal of claim 6, wherein the logic is further configured to:
synchronize the received information with the selected song.

8. The mobile terminal of claim 6, wherein the received information comprises a video pre-programmed to display images synchronized with the selected song.

9. The mobile terminal of claim 6, wherein the logic is further configured to:
store the received information.

10. The mobile terminal of claim 6, wherein when simultaneously outputting the selected song and received information, the logic is configured to simultaneously output the selected song and the received information to a stereo system and a television.

11. A method comprising:
selecting a song;
receiving song lyrics associated with the selected song via a network;
receiving input from a microphone;
combining at least a portion of the selected song and the received input from the microphone to form a combined music signal; and
simultaneously outputting the combined music signal to a first output device and outputting the song lyrics to a second output device.

12. The method of claim 11, further comprising:
suppressing vocal information in the selected song.

13. The method of claim 11, wherein the first output device comprises a stereo system and the second output device comprises a monitor.

14. The method of claim 11, further comprising:
transmitting information identifying the selected song to a server, wherein the server identifies the selected song and obtains song lyrics associated with the selected song.

15. The method of claim 11, further comprising:
synchronizing the received song lyrics with the selected song.

16. A mobile terminal, comprising:
a memory for storing a plurality of songs;
a microphone for receiving input; and
logic configured to:
select one of the plurality of songs stored in the memory;
receive song lyrics associated with the selected song;
combine the received input from the microphone with at least a portion of the selected song to form a combined music signal; and
simultaneously outputting the combined music signal to a first output device and outputting the received song lyrics to a second output device.

17. The mobile terminal of claim 16, wherein the logic is further configured to:
suppress vocals in the selected song.

18. The mobile terminal of claim 17, wherein the logic is further configured to:
synchronize the combine music signal with the received song lyrics associated with the selected song.

19. The mobile terminal of claim 16, wherein the logic is further configured to:
transmit information identifying the selected song to a server, wherein the server identifies the selected song and obtains song lyrics associated with the selected song.

20. The mobile terminal of claim 16, wherein the first output device comprises a stereo system and the second output device comprises a television.

21. A mobile terminal comprising:
means for selecting a song;
means for transmitting information identifying the selected song to a server;
means for receiving information associated with the selected song from the server; and
means for simultaneously outputting the selected song and the received information.

22. The mobile terminal of claim 21, wherein the received information comprises at least one of concert related information or information associated with purchasing a song.

23. The mobile terminal of claim 21, wherein the received information comprises at least a portion of a song by a same artist or group associated with the selected song.

24. The mobile terminal of claim 21, wherein the means for simultaneously outputting the selected song and the received information further comprises:
means for outputting the selected song via a speaker on the mobile terminal and means for outputting the received information via a display on the mobile terminal.
